(19) United States
(12) Patent Application Publication
(10) Pub. No.: US 2010/0003997 A1
(43) Pub. Date: Jan. 7, 2010

(54) Radio Base Station And Radio Communication Method Therefor

(75) Inventor: Kenichiro KOYANAGI, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki (JP)

(21) Appl. No.: 12/472,089

(22) Filed: May 26, 2009

(30) Foreign Application Priority Data
Jul. 4, 2008 (JP) 2008-175300

(51) Int. Cl. H04W 72/04

(52) U.S. Cl. 455/450

(57) ABSTRACT

A radio base station transmits data to a mobile station in the form of error correction coded blocks. To this end, a controller allocates radio resources belonging to a first set of radio resources to one part of a block of data, as well as radio resources belonging to a second set of radio resources to the other part of the block. The first set of radio resources is a set of radio resources assigned to the radio base station for use in data transmission, while the second set of radio resources is a set of radio resources other than the first set of radio resources. A transceiver transmits the block by using the radio resources that the controller has allocated.

### CROSS-REFERENCE TO RELATED APPLICATION(S)

This application is based upon and claims the benefit of priority of the prior Japanese Patent Application No. 2008-175300, filed on Jul. 4, 2008, the entire contents of which are incorporated herein by reference.

### FIELD

The embodiments discussed herein are related to a radio base station and a radio communication method therefor.

### BACKGROUND

Mobile communications systems use an error correction coding technique to correct errors that occur during data transmission. At the transmitting end, data is divided into blocks of a certain size and transmitted in the form of coded blocks. The error correction coding permits the receiving end to detect and correct errors in received data blocks, thus reproducing the original correct data.

The service coverage area of a mobile communications system is segmented into a plurality of cells each served by a radio base station. From the viewpoint of communication capacity, it is desirable in such a cellular system that each cell be allocated as wide a frequency band as possible. From the viewpoint of communication quality, on the other hand, it has to be avoided to use the same frequency band in two or more cells (or at least in neighboring cells) because doing so would lead to interference of radio signals transmitted from different cells.

The radio base station communicates with mobile stations by using a duplex technique such as Time Division Duplex (TDD). In the TDD system, each radio frame provides separate time slots for downlink channels (base station to mobile station) and uplink channels (mobile station to base station). In terms of communication capacity, it is preferable in TDD applications that the ratio between uplink and downlink slot sizes be changed adaptively in each cell, according to the condition of communication. This means, however, that a plurality of cells may switch between uplink and downlink time slots asynchronously, thus possibly causing interference between radio waves from the radio base station in a cell and those from a mobile station in another cell. For this reason, it is preferable to synchronize the uplink and downlink time slots of different cells to achieve a better communication quality.

As can be seen from the above, mobile communications systems are preferably designed to achieve not only efficient use of radio resources, but also effective suppression of inter-cell interference. To this end, Japanese Laid-open Patent Publication No. 2002-232940, for example, proposes a method for use in TDD systems to improve the efficiency of radio resource usage. Specifically, the proposed method allows using one kind of time slot (e.g., uplink slot) to expand the other kind of time slot (e.g., downlink slot) when the former time slot has sufficient room, and if that time slot is not experiencing serious interference from mobile stations in other cells.

The above-noted method (i.e., Japanese Laid-open Patent Publication No. 2002-232940) makes it possible to use time slot resources for a purpose not originally intended, when the radio interference from other cells' mobile stations is relatively small. In other words, the proposed method is applicable only to a limited number of mobile stations enjoying such peaceful conditions. The reason is as follows. A significant interference would degrade the quality of radio signals to the point where transmission error is too severe for the error correction coding to serve its purpose. The resulting increased block error rate makes it meaningless to allocate time slot resources for other purposes. That is, the above-noted method is inefficient because of its limited applicability.

### SUMMARY

According to an aspect of the present invention, a radio base station transmits data in the form of error correction coded blocks. This radio base station includes, among other things, a controller and a transmitter. The controller allocates radio resources belonging to a first set of radio resources to one part of a block of data, as well as radio resources belonging to a second set of radio resources to the other part of the block. Here the first set of radio resources is a set of radio resources assigned to the radio base station for use in data transmission, while the second set of radio resources is a set of radio resources other than the first set of radio resources. The transmitter transmits the block by using the radio resources allocated by the controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 provides an overview of a radio communications system;

FIG. 2 illustrates a radio communications system;

FIG. 3 is a block diagram illustrating a radio base station according to a first embodiment;

FIG. 4 illustrates a radio frame structure according to the first embodiment;

FIG. 5 illustrates synchronized use of subframes according to the first embodiment;

FIG. 6 is a flowchart of DL communication control according to the first embodiment;

FIGS. 7A and 7B illustrate examples of DL block allocation according to the first embodiment;

FIG. 8 is a flowchart of UL communication control according to the first embodiment;

FIGS. 9A and 9B illustrate examples of UL block allocation according to the first embodiment;

FIG. 10 is a first graph illustrating relationships between radio quality and block error rate;

FIG. 11 is a block diagram illustrating a radio base station according to a second embodiment;

FIG. 12 is a flowchart of DL communication control according to the second embodiment;

FIG. 13 is a flowchart of UL communication control according to the second embodiment;

FIG. 14 is a second graph illustrating relationships between radio quality and block error rate;

FIG. 15 illustrates a radio frame structure according to a third embodiment;

FIG. 16 illustrates allocation of frequency bands according to the third embodiment;

FIG. 17 is a flowchart of DL communication control according to the third embodiment;

FIGS. 18A and 18B illustrate examples of DL block allocation according to the third embodiment;

FIG. 19 is a flowchart of UL communication control according to the third embodiment;

FIG. 20 is a flowchart of DL communication control according to a fourth embodiment; and

FIG. 21 is a flowchart of UL communication control according to the fourth embodiment.

### DESCRIPTION OF EMBODIMENT(S)

Preferred embodiments of the present invention will now be described in detail below with reference to the accompanying drawings, wherein like reference numerals refer to like elements throughout.

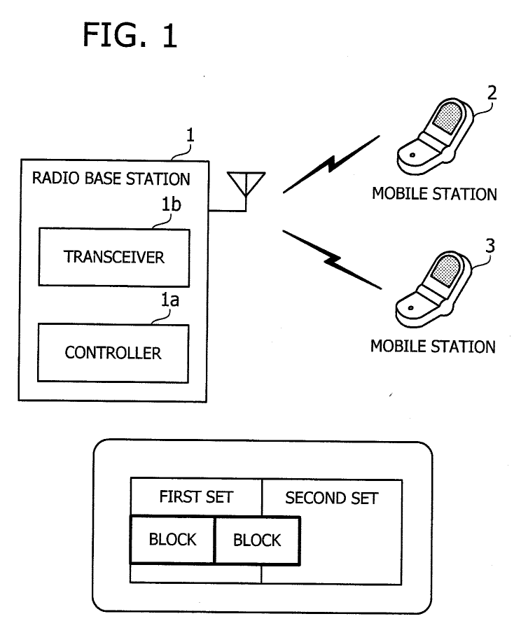

FIG. 1 provides an overview of a radio communications system. This radio communications system includes a radio base station 1 and mobile stations 2 and 3. The radio base station 1 is an apparatus that communicates wirelessly with mobile stations 2 and 3. The mobile stations 2 and 3 are portable terminal devices capable of communicating wirelessly with the radio base station 1.

Radio resources used by the radio base station 1 and mobile stations 2 and 3 in their communication include radio frames transmitted at predetermined intervals and a frequency band with a predetermined bandwidth assigned to the radio base station 1. The radio base station 1 divides those radio resources to achieve multiplex and duplex communication with a plurality of mobile stations. Multiplexing methods used for this purpose include, for example, time-division multiple access (TDMA) and frequency-division multiple access (FDMA). Duplexing methods include time-division duplexing (TDD) and frequency-division duplexing (FDD). Data is transported between the radio base station 1 and mobile station 2 and 3 on a block basis; that is, transmit data is divided into blocks of a specified size. Those blocks are subjected to error correction coding before they are transmitted.

The radio base station 1 includes a controller 1a and a transceiver 1b. The controller la allocates radio resources belonging to a first set of radio resources to one part of a block of data. The first set of radio resources is a set of radio resources assigned to the radio base station for use in data transmission. The controller la also allocates radio resources belonging to a second set of radio resources to the other part of the block. The second set of radio resources is a set of radio resources other than the first set of radio resources.

The transceiver 1b transmits the block to the mobile stations 2 and 3 by using the radio resources allocated by the controller 1a. When receiving a block, the transceiver 1b transmits to the mobile stations 2 and 3 a piece of information indicating such radio resources allocated by the controller 1a.

The mobile stations 2 and 3 receive blocks addressed to themselves, using the radio resources allocated by the controller 1a. The mobile stations 2 and 3 also transmit blocks to the radio base station 1, based on the information indicating radio resources allocated by the controller 1a.

The two sets of radio resources noted above may be, for example, radio frames which are provided separately for uplink and downlink communication between the radio base station 1 and mobile stations 2 and 3. In the case of downlink communication, the first set of radio resources refers to radio frames which are intended for transmission of blocks from the radio base station 1 to the mobile stations 2 and 3. The second set of radio resources, on the other hand, refers to radio frames which are intended, not originally for downlink transmission, but for uplink transmission from the mobile stations 2 and 3 to the radio base station 1.

Another example of radio resources is frequency bands assigned to base stations. For example, the radio base station 1 uses resources of a particular frequency band that does not overlap with those of surrounding radio base stations (not illustrated). The first set of radio resources in this case refers to a frequency band assigned to the radio base station 1 for communication with mobile stations 2 and 3 in its own coverage area. The second set of radio resources, on the other hand, refers to frequency bands that have been assigned, not to the radio base station 1, but to other base stations. The former frequency band does not overlap with the latter frequency bands to avoid radio interference between neighboring radio coverage areas.

The first-set resources offer better radio link quality when they are used for its intended purpose (e.g., for downlink communication). On the other hand, the second-set resources may be used for an unintended purpose (e.g., for downlink communication). But in that case the user could experience degradation of radio link quality due to radio interference.

In operation of the above-described radio communications system, a first set of radio resources (referred to also as “first-set resources” where appropriate) is provided for the purpose of transporting coded blocks through a particular link or set of links. Other radio resources are referred to as a second set of radio resources (or “second-set resources”). First-set resources are allocated to a part of a coded block to be transmitted, while second-set resources are allocated to the remaining part of the coded block.

Suppose, for example, that the radio base station 1 is transmitting data to mobile stations 2 and 3. In this situation, each coded block is partly mapped to resources intended for that data transmission purposes. The rest of each coded block is mapped to resources intended for data reception purposes, despite the fact that those resources are not originally prepared for transmission of coded blocks. (The resources for data transmission are first-set resources, and those for data reception are second-set resources in this case.) Radio signals corresponding to the allocated resources convey the coded blocks to the mobile stations 2 and 3. The receiving mobile stations 2 and 3 extract each coded block by combining a part received using the first-set resources with the remaining part received using the second-set resources. Each extracted coded block is then subjected to error detection and correction processes for recovery from bit errors if any.

The risk of quality degradation on the part of second-set resources can be compensated by better communication quality of first-set resources. It is therefore possible to maintain a sufficient total quality of individual coded blocks, thus achieving low block error rates.

In spite of inferior communication quality of the second set of radio resources, the above-described mechanism enables allocation of those radio resources for the purpose of communication with mobile stations 2 and 3. This means that the proposed radio communications system uses radio resources more efficiently.

### First Embodiment

This section will describe a first embodiment of the present invention in detail with reference to the accompanying drawings.

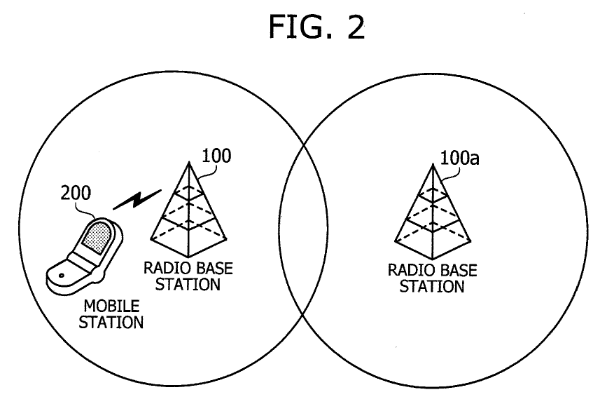

FIG. 2 illustrates a radio communications system. This radio communications system includes radio base stations 100 and 100a and a mobile station 200. The mobile station 200 resides in the radio coverage area, or cell, of one radio base station 100. While not illustrated in FIG. 2, the two radio base stations 100 and 100a are connected with their upper-level stations and/or other radio base stations via wired or wireless links.

The radio base stations 100 and 100a are communication devices that can communicate with a plurality of mobile stations via radio waves. The mobile station 200 currently visiting the cell of the radio base station 100 is a mobile communication terminal (e.g., cellular phone) that can communicate with the radio base station 100 via radio waves. When it has some user data or control data to transmit, the mobile station 200 first receives an allocation of radio resources from the radio base station 100 and then transmits such data using the allocated radio resources. When a signal arrives from the radio base station 100, and if the signal indicates that the data is addressed to the mobile station 200 itself, the mobile station 200 extracts user data or control data from the received signal.

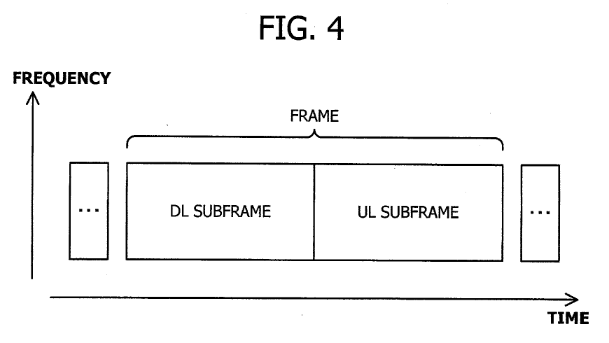

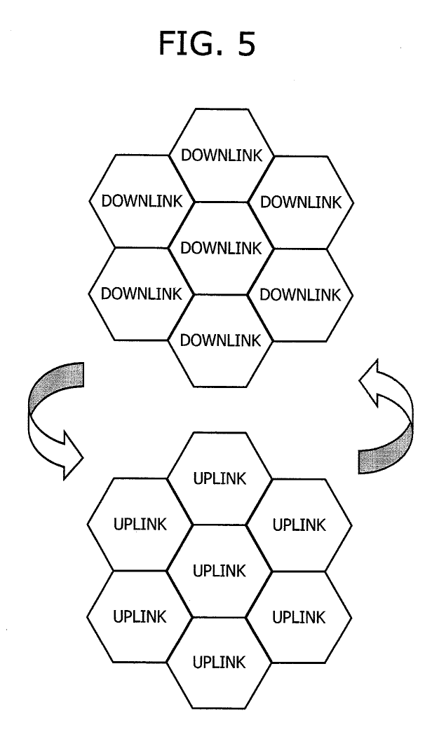

Those radio base stations 100 and 100a communicate with mobile stations by using a multiplexing technique such as the orthogonal frequency-division multiple access (OFDMA). They also use a time-division duplex (TDD) technique to communicate with a mobile station in both directions at the same frequency. According to the TDD technique, the radio frame is formed from a downlink (DL) subframe and an uplink (UL) subframe. More specifically, the DL subframe refers to a time slot that carries transmit data from base station to mobile station, and the UL subframe refers to a time slot that carries receive data from mobile station to base station. To minimize the interference between uplink and downlink radio signals, the radio base stations 100 and 100a are synchronized with each other in sending and receiving those DL and UL subframes. Detailed structure of DL/UL subframes will be discussed later with reference to FIGS. 4 and 5.

The radio base stations 100 and 100a and mobile stations transmit data to each other in the form of coded blocks. Specifically, transmit data is divided into blocks of a specified size, which are then subjected to error detection/correction coding and interleaving before they are transmitted.

The following description will discuss what functions are provided in the radio base station 100. While not explained explicitly, the other radio base station 100a provides the same functions.

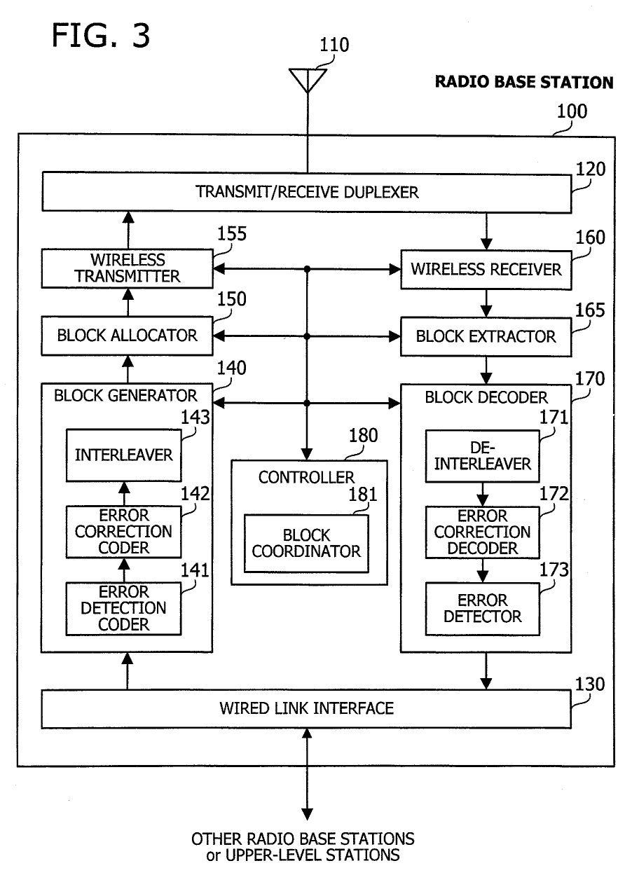

FIG. 3 is a block diagram illustrating a radio base station according to the first embodiment. This radio base station 100 includes the following elements: an antenna 110, a transmit/receive duplexer 120, a wired link interface 130, a block generator 140, a block allocator 150, a wireless transmitter 155, a wireless receiver 160, a block extractor 165, a block decoder 170, and a controller 180.

The antenna 110 serves for both transmission and reception of radio signals. Specifically, the antenna 110 is connected to a transmit/receive duplexer 120 that offers switching between transmission and reception. The antenna 110 radiates transmit signals supplied from the transmit/receive duplexer 120, in the form of radio waves. The antenna 110 also receives radio signals and supplies them to the transmit/receive duplexer 120.

The transmit/receive duplexer 120 includes a high-frequency switch to control switching between transmission and reception of radio signals via the antenna 110. Specifically, the transmit/receive duplexer 120 supplies the antenna 110 with radio signals produced by a wireless transmitter 155. In addition, the transmit/receive duplexer 120 routes received radio signals from the antenna 110 to the wireless receiver 160.

The wired link interface 130 communicates with other radio base stations and upper-level stations (not illustrated) via a wired network. Specifically, the wired network delivers user data addressed to the mobile station 200. The wired link interface 130 receives this user data and supplies it to a block generator 140. The wired link interface 130 also sends user data from a block decoder 170 to other radio base stations or upper-level stations via the network.

The block generator 140 divides transmit data into blocks of a size specified by the controller 180. By coding and interleaving those blocks, the block generator 140 produces coded blocks for downlink transmission (referred to hereafter as “DL blocks”). The block generator 140 supplies the produced DL block to a block allocator 150.

The block generator 140 includes an error detection coder 141, an error correction coder 142, and an interleaver 143. The error detection coder 141 executes error detection coding on each given DL block and supplies the result to the error correction coder 142. The error correction coder 142 then subjects the error detection-coded block to error correction coding and passes the result to the interleaver 143. The coding method used here may be, for example, convolutional coding or turbo coding. The radio base station 100 previously negotiates with the mobile station 200 about what coding method should be used and executes coding of data blocks according to that agreed-upon method. This is also true for the other direction of data transmission, i.e., from mobile station 200 to radio base station 100.

The interleaver 143 produces a DL block by applying an interleaving operation on the error correction coded block. Here, the term “interleaving” refers to a process of modifying arrangement of bits so that adjacent bits will be assigned to separate resources. This process protects the transmission of blocks against burst errors (i.e., contiguous bit errors), which the blocks may encounter during their propagation over a transmission channel.

The controller 180 provides the block allocator 150 with MAP information that defines the arrangement of blocks in a radio frame. Upon receipt of DL blocks from the block generator 140, the block allocator 150 arranges them in a radio frame, based on the MAP information. The resulting radio frame data will be handled as a protocol data unit (PDU) for transmission in the radio link section. In this operation, the block allocator 150 adds MAP information into the produced radio frame data to indicate how the resources are used in that radio frame. Subsequently the block allocator 150 outputs the produced radio frame data to the wireless transmitter 155. Note that the MAP information in a radio frame includes some identifiers indicating the modulation and coding methods used in each block.

The MAP information defines arrangement of blocks separately for downlink and uplink directions. Specifically, downlink MAP information (hereafter “DL-MAP information”) applies to DL subframes, while uplink MAP information (hereafter “DL-MAP information”) applies to UL subframes.

The wireless transmitter 155 modulates a carrier signal with the radio frame data supplied from block allocator 150. This modulation is performed according to the modulation method specified by the controller 180. The wireless transmitter 155 then supplies the resulting transmit signal to the transmit/receive duplexer 120.

The wireless receiver 160 demodulates receive signals supplied from the transmit/receive duplexer 120 This demodulation is performed according to a demodulation method specified by the controller 180. The wireless receiver 160 then supplies the resulting radio frame data to the block extractor 165.

The block extractor 165 extracts uplink blocks (“UL blocks”) out of the radio frame data supplied from the wireless receiver 160, based on UL-MAP information in the radio frames according to instructions of the controller 180. The block extractor 165 then supplies the extracted UL blocks to the block decoder 170.

The block decoder 170 reproduces user data from the UL blocks supplied from the block extractor 165 by de-interleaving, decoding, and recombining them. The reproduced user data is then supplied to the wired link interface 130. To this end, the block decoder 170 includes a de-interleaver 171, an error correction decoder 172, and an error detector 173.

The de-interleaver 171 applies a de-interleaving operation to the UL blocks extracted by the block extractor 165, thereby reproducing error correction coded blocks for further processing in the subsequent error correction decoder 172. The error correction decoder 172 applies an error correction decoding operation to the reproduced coded blocks and supplies the resulting corrected blocks to the error detector 173. The error detector 173 then examines whether those blocks have an error. The error detector 173 outputs the blocks if no error is found. If an error is found in a block, the error detector 173 requests the sending mobile station 200 to retransmit the same block, while discarding the received block. Finally, the user data is reproduced from the sequence of blocks which have been successfully decoded without errors.

The controller 180 determines whether to allocate resources of UL subframe, in addition to those of DL subframe, for the purpose of transmission of DL blocks. This decision is made on the basis of, for example, the usage rates of DL and UL subframes or other parameters representing the current condition of communication. The controller 180 also selects a mobile station(s) for which such UL subframe resources will be used together with DL subframe resources to transmit DL blocks. This selection may be made arbitrarily or randomly or according to a particular sequence of mobile stations. It may also be possible to take into account the amount of transmit data and/or the quality of radio links, for example.

The controller 180 also makes various decisions for incoming UL blocks, similarly to the DL blocks discussed above. That is, the controller 180 determines whether to allocate resources of DL subframe, in addition to those of UL subframe, for the purpose of reception of UL blocks. This decision is made on the basis of, for example, the usage rates of DL and UL subframes or other parameters representing the current condition of communication. The controller 180 also selects a mobile station(s) for which such DL subframe resources will be used. This selection may be made arbitrarily or randomly or according to a particular sequence of mobile stations. It may also be possible to take into account the amount of receive data and/or the quality of radio links, for example.

To produce DL blocks, the controller 180 provides the block generator 140 with some parameters of DL blocks (e.g., block size). Likewise, to decode received UL blocks, the controller 180 provides the block decoder 170 with some parameters of those UL blocks (e.g., block size). To allocate resources to DL blocks, the controller 180 sends DL-MAP information to the block allocator 150. Further, to extract UL blocks, the controller 180 sends UL-MAP information to the block extractor 165. In addition to the above, the controller 180 informs the wireless transmitter 155 of which modulation method to use, as well as the wireless receiver 160 of which demodulation method to use.

The controller 180 includes a block coordinator 181 to determine the location of coded blocks in a radio frame. This block coordinator 181 decides the size of a single block. The DL block size refers to the amount of data contained in a block that the block generator 140 produces. Similarly, the UL block size means the amount of data in a UL block that a mobile station produces as an outcome of its coding and interleaving operations. Such block sizes may previously be specified as a fixed size, or determined according to the current condition of communication (e.g., the amount of transmit and receive data traffic).

The block coordinator 181 also determines locations of coded blocks in a radio frame to produce DL- and UL-MAP information. Specifically, the block coordinator 181 allocates available subframe resources to coded blocks. If necessary, the block coordinator 181 allocates different resources to different parts of a single coded block. For example, one part is placed in a subframe that is intended for such blocks, while the other part of the same block is placed in a subframe that is not originally intended for such blocks.

FIG. 4 illustrates a radio frame structure according to the first embodiment. A radio frame is defined as a range of frequency bands assigned to the radio base station 100, with a certain length of time. Each radio frame is divided along the time axis into two sections called DL subframe and UL subframe, whose dimensions on the frequency and time axes are previously defined. The radio base station 100 and mobile station 200 repetitively transmit and receive radio signals carrying such radio frames.

DL subframe is a subframe used for communication in the downlink direction, i.e., from radio base station 100 to mobile station 200. While not specifically illustrated, a DL subframe includes, among other things, a preamble, DL/UL-MAP information field, and resource fields for carrying DL blocks. Mobile stations use the preamble for their frequency synchronization and frame timing synchronization. They also use the preamble to measure the radio link quality. The DL/UL-MAP information permits mobile stations to recognize which part of DL/UL block resources is assigned to them, as well as to learn what modulation coding methods are used or will be used to transport coded blocks.

UL subframe is a subframe for uplink communication, which provides resource fields to carry UL blocks from a mobile station 200 to the radio base station 100. The mobile station 200 uses such UL-block resource fields assigned by the radio base station 100 to send user data to the radio base station 100. The mobile station 200 also uses some of the assigned resource fields to inform the radio base station 100 of the current radio link quality, which can be measured from the preamble of received DL subframes.

FIG. 5 illustrates synchronized use of subframes according to the first embodiment. Specifically, FIG. 5 depicts an arrangement of cells (radio coverage areas) of radio base stations, including the foregoing radio base station 100. As can be seen from FIG. 5, a plurality of radio base stations synchronize their DL/UL subframes, so as to minimize the interference between uplink and downlink radio signals while allowing independent operations of uplink and downlink. That is, during one time period (see upper half of FIG. 5), all radio base stations transmit signals using their respective DL subframes. During another time period (see lower half of FIG. 5), all radio base stations receive signals using their respective UL subframes.

The following description gives details of several processes executed in the above-described radio communications system. It is assumed here that the radio base station 100 exchanges data with a plurality of mobile stations including the mobile station 200.

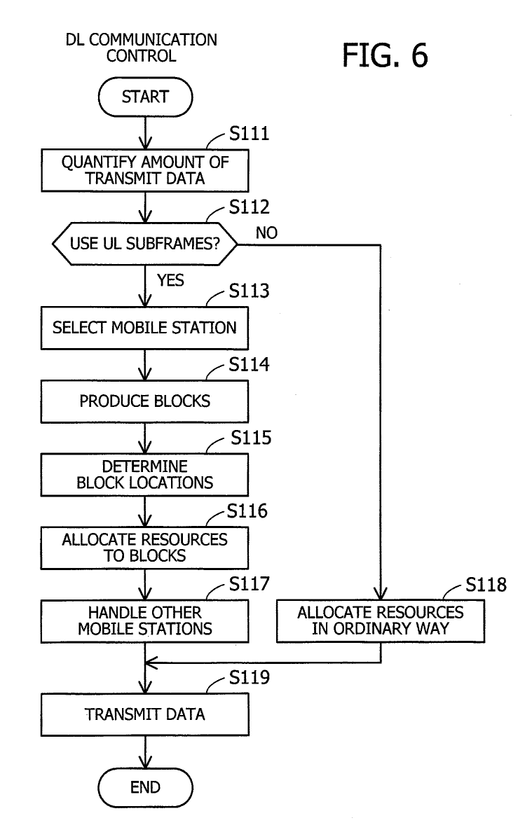

FIG. 6 is a flowchart of DL communication control according to the first embodiment. The illustrated process proceeds according to the following steps:

(Step S111) The controller 180 interacts with the wired link interface 130 to receive outgoing user data to be transmitted to mobile stations. The controller 180 then quantifies the amount of this user data and informs the block coordinator 181 of the result. Based on this information, the block coordinator 181 determines the size of a single DL block.

(Step S112) Based on the current usage of DL/UL subframes, the controller 180 determines whether to use UL subframes to send blocks to mobile stations. This determination may be based on, for example, whether the usage rate of UL subframes is lower than a specific threshold. If it is determined to use a UL subframe for block transmission, the process advances to step S113. If it is determined not to use UL subframes for block transmission, the process branches to step S118.

(Step S113) The controller 180 selects a mobile station(s) for which a UL subframe is to be used in block transmission. This selection may be made arbitrarily or randomly or according to a particular sequence of mobile stations. It may also be possible to take into account the amount of transmit data and/or the quality of radio links, for example. The selection is not limited to a single mobile station; the controller 180 may select two or more mobile stations.

(Step S114) Based on the block size determined by the block coordinator 181, the block generator 140 divides the user data into blocks and subjects them to error detection coding, error correction coding, and interleaving operations. The block generator 140 then supplies the resulting DL blocks to the block allocator 150.

(Step S115) The block coordinator 181 determines where in the radio frame to place the produced DL blocks, thus generating DL-MAP information. In this processing, DL subframe resources are allocated to a part of each DL block for the mobile station selected at the above step S113. Allocated to the remaining part of each DL block are UL subframe resources. The ratio between DL subframe resources and UL subframe resources allocated to each DL block may be determined by radio link quality requirements to achieve a specified quality of service (QoS) of DL blocks, or by the total usage rate of DL and UL subframes. The controller 180 sends DL-MAP information produced by the block coordinator 181 to the block allocator 150.

(Step S116) According to the DL-MAP information provided from the controller 180, the block allocator 150 begins to produce radio frame data by executing the allocation of radio frame resources to the DL blocks supplied from the block generator 140. In this process, the block allocator 150 adds the DL-MAP information into radio frame data.

(Step S117) The block allocator 150 now turns to other mobile stations, whose DL blocks will be transmitted in an ordinary way, i.e., by using only DL subframes. The block allocator 150 allocates DL subframe resources to the DL blocks of those mobile stations, thus completing the production of radio frame data. The block allocator 150 then supplies the completed radio frame data to the wireless transmitter 155.

(Step S118) The block coordinator 181 determines where in the radio frame to place DL blocks of all mobile stations, so that the DL blocks will be transmitted in an ordinary way, i.e., by using only DL subframe resources. The results are compiled as DL-MAP information. The controller 180 then sends the produced DL-MAP information to the block allocator 150. Based on this DL-MAP information, the block allocator 150 allocates radio frame resources to the DL blocks, thus producing radio frame data for transmission via the wireless transmitter 155. In this process, the block allocator 150 adds the DL-MAP information into radio frame data.

(Step S119) The wireless transmitter 155 modulates a carrier signal with the radio frame data supplied from the block allocator 150 according to the modulation method specified by the controller 180. The wireless transmitter 155 outputs the resulting transmit signal to the antenna 110 via the transmit/receive duplexer 120. The transmit signal is thus radiated as radio waves from the antenna 110 to mobile stations.

Through the above-described steps, the radio base station 100 allocates DL and UL subframe resources to DL blocks for transmission to selected mobile stations. The receiving mobile stations use DL-MAP information to extract DL blocks addressed to them, thereby obtaining user data contained therein.

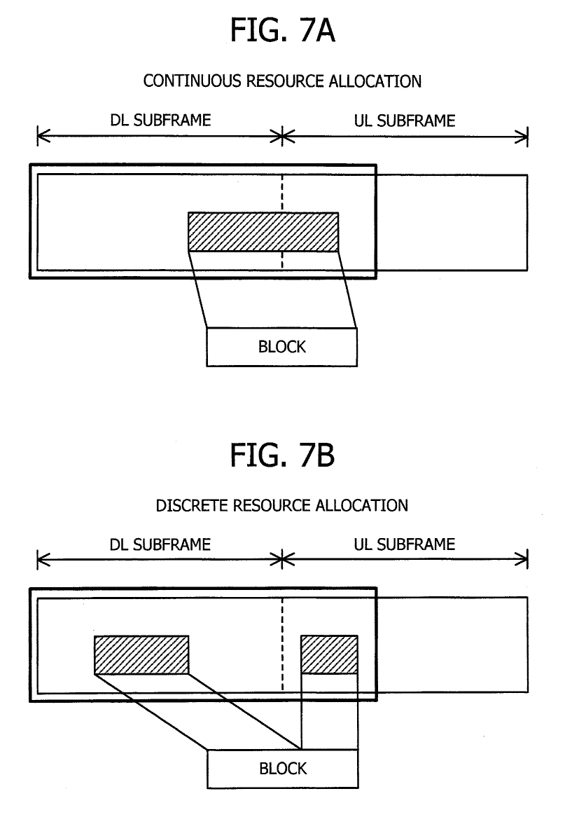

FIGS. 7A and 7B illustrate examples of DL block allocation according to the first embodiment. Specifically, FIG. 7A illustrates the case where a DL block is allocated a set of resources in a continuous region that lies across the DL and UL subframes. This continuous allocation makes it easy for the receiving mobile stations to locate and read DL blocks, thus reducing their workload in decoding received data.

FIG. 7B, on the other hand, illustrates the case where a DL block is allocated a set of resources in discrete regions of the DL and UL subframes. This discontinuous allocation contributes to more flexible and efficient arrangement of blocks.

In the examples of FIGS. 7A and 7B, the DL subframe is extended toward a front-end portion of UL subframe for the purpose of mapping more DL blocks. It may also be possible to place DL blocks in a back-end portion of UL subframe.

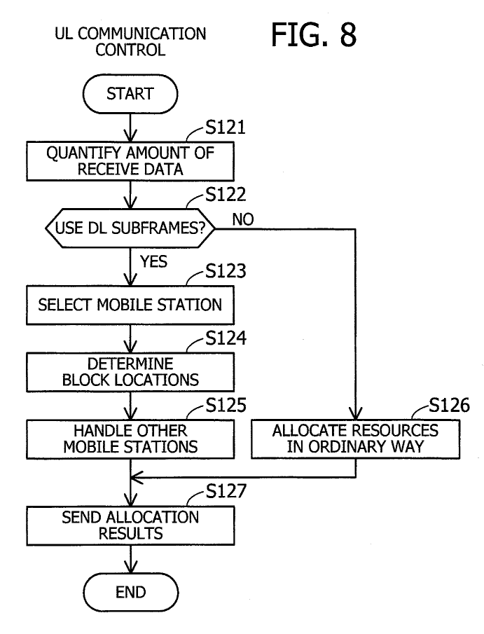

FIG. 8 is a flowchart of UL communication control according to the first embodiment. The illustrated process proceeds according to the following steps:

(Step S121) The controller 180 quantifies how much user data will be received from mobile stations and informs the block coordinator 181 of the result. Based on this information, the block coordinator 181 determines the size of a single UL block.

(Step S122) Based on the current usage of DL/UL subframes, the controller 180 determines whether to use DL subframes to receive blocks from mobile stations. This determination may be based on, for example, whether the usage rate of DL subframes is lower than a specific threshold. If it is determined to use DL subframe for block reception, the process advances to step S123. If it is determined not to use DL subframe for block reception, the process branches to step S126.

(Step S123) The controller 180 selects a mobile station(s) for which a DL subframe is to be used in block reception. This selection may be made arbitrarily or randomly or according to a particular sequence of mobile stations. It may also be possible to take into account the amount of receive data and/or the quality of radio links, for example. The selection is not limited to a single mobile station; the controller 180 may select two or more mobile stations.

(Step S124) The block coordinator 181 determines where in the radio frame to place UL blocks, thus producing UL-MAP information. In this processing, UL subframe resources are allocated to a part of each UL block for the mobile station selected at the above step S123. Allocated to the remaining part of each UL block are DL subframe resources. The ratio between DL subframe resources and UL subframe resources allocated to each UL block may be determined by radio link quality requirements to achieve a specified QoS of UL blocks, or by the total usage rate of DL and UL subframes.

(Step S125) The block coordinator 181 produces UL-MAP information for other mobile stations, whose UL blocks will be transported by using only UL subframes.

(Step S126) The block coordinator 181 determines where in the radio frame to place UL blocks of all mobile stations, so that their UL blocks will be received in an ordinary way, i.e., by using only UL subframe resources. The results are compiled as UL-MAP information.

(Step S127) The controller 180 then sends the produced UL-MAP information to the block allocator 150. The block allocator 150 produces radio frame data containing this UL-MAP information. The produced radio frame data is transmitted as radio waves via the wireless transmitter 155, transmit/receive duplexer 120, and antenna 110.

Through the above-described steps, the radio base station 100 provides each mobile station with UL-MAP information describing allocation of DL and UL subframe resources for use in reception of UL blocks from selected mobile stations. The mobile stations use assigned resources to transmit their own UL blocks to the radio base station 100.

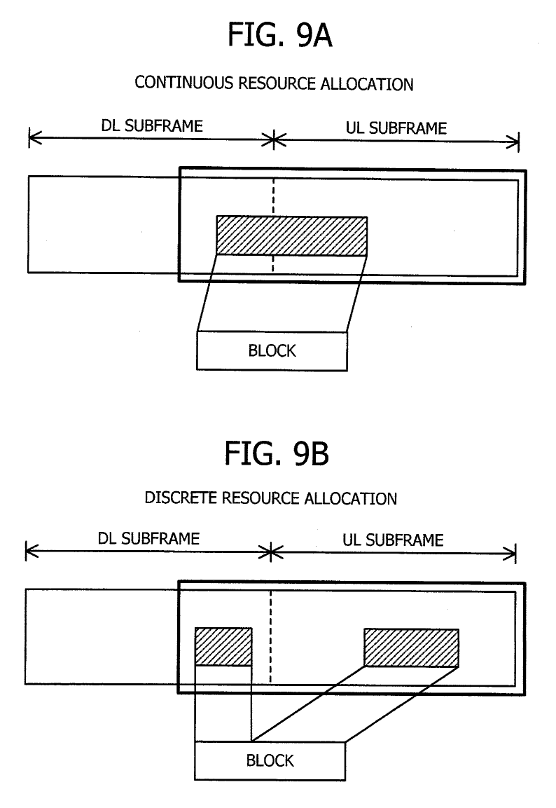

FIGS. 9A and 9B illustrate examples of UL block allocation according to the first embodiment. Specifically, FIG. 9A illustrates the case where a UL block is allocated a set of resources in a continuous region that lies across the DL and UL subframes. This continuous allocation makes it easy for the radio base station to locate and read UL blocks, thus reducing its workload in decoding received data.

FIG. 9B, on the other hand, illustrates the case where a UL block is allocated a set of resources in discrete regions of the DL and UL subframes. This discontinuous allocation contributes to more flexible and efficient arrangement of blocks.

In the examples of FIGS. 9A and 9B, the UL subframe is extended forward to a back-end portion of DL subframe. It may also be possible to place UL blocks in a front-end portion of DL subframe.

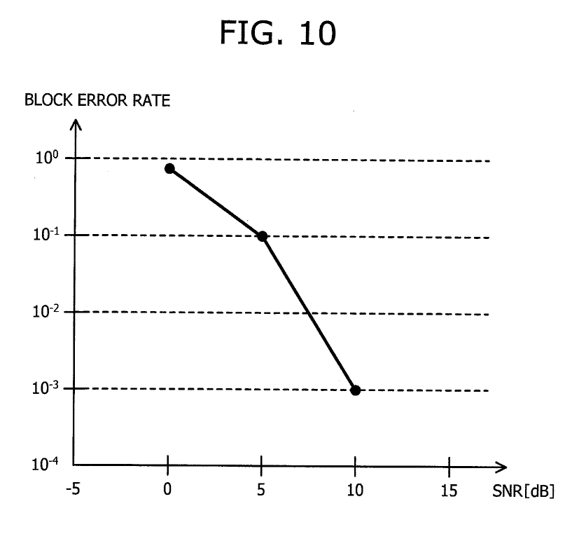

FIG. 10 is a first graph illustrating relationships between radio quality and block error rate. The horizontal axis of this graph represents signal to noise ratios (SNR) in units of decibels (dB), while the vertical axis represents block error rates.

Suppose, for example, that the radio base station 100 sends DL blocks to a mobile station 200. When DL subframes provide a radio link quality of 7.5 dB, the block error rate in this case is 1.0×10⁻² as FIG. 10 indicates. When UL subframe resources are used to transmit DL blocks, possible interference from mobile stations in other cells would degrade the radio link quality to, for example, 0 dB at the mobile station 200. In this case, the block error rate rises up to 9.0×10⁻¹ as can be seen from FIG. 10. That is, the mobile station 200 experiences a significant degradation of radio link quality when UL subframe resources are used to send DL blocks, contrary to their intended use.

Suppose now that the radio base station 100 allocates DL subframe resources and UL subframe resources at the ratio of 3:1 for transmission of DL blocks. Then the resulting average radio link quality is about 6.5 dB per DL block, the corresponding block error rate being about 2.0×10⁻² as FIG. 10 indicates. As can be seen from this example, the combined use of DL and UL subframe resources offers much better block error rates, in contrast to the case of using only UL subframe resources to send DL blocks.

While the above discussion is directed to block error rates of DL blocks sent from the radio base station 100 to the mobile station 200, the same discussion applies also to resource allocation of UL blocks that the radio base station 100 receives from the mobile station 200.

As can be seen from the above, the radio communications system permits coded blocks to be transmitted and received by using not only a portion of radio frame resources intended for respective link directions, but also a portion of radio frame resources that are originally intended for opposite link directions. Even though the quality of the latter portion of radio frame resources may not be good, the former portion of radio frame resources makes it possible to guarantee an average radio link quality for coded blocks. This also means that it is possible to make more efficient use of radio link resources by mapping coded blocks to those not originally intended for that purpose, while maintaining a specified communication quality.

### Second Embodiment

This section will now describe a second embodiment of the present invention in detail with reference to the accompanying drawings. Because of the similarity of this second embodiment to the foregoing first embodiment, the following description will focus on their differences, not repeating the explanation of similar elements or features.

The second embodiment introduces an adaptive modulation technique into the communication between a radio base station and mobile stations in a mobile communications system. This adaptive modulation system allows the radio base station to change modulation methods depending on the radio link quality of mobile stations. The second embodiment takes into consideration the size and arrangement of DL/UL blocks so that the mobile communications system can ensure a specified radio link quality. The following description is directed to a radio base station and a mobile station used in the proposed mobile communications system.

The mobile communication system of the second embodiment is configured in the same way as the first embodiment illustrated in FIG. 2. The radio frame structure of FIG. 4 discussed in the first embodiment also applies to the second embodiment.

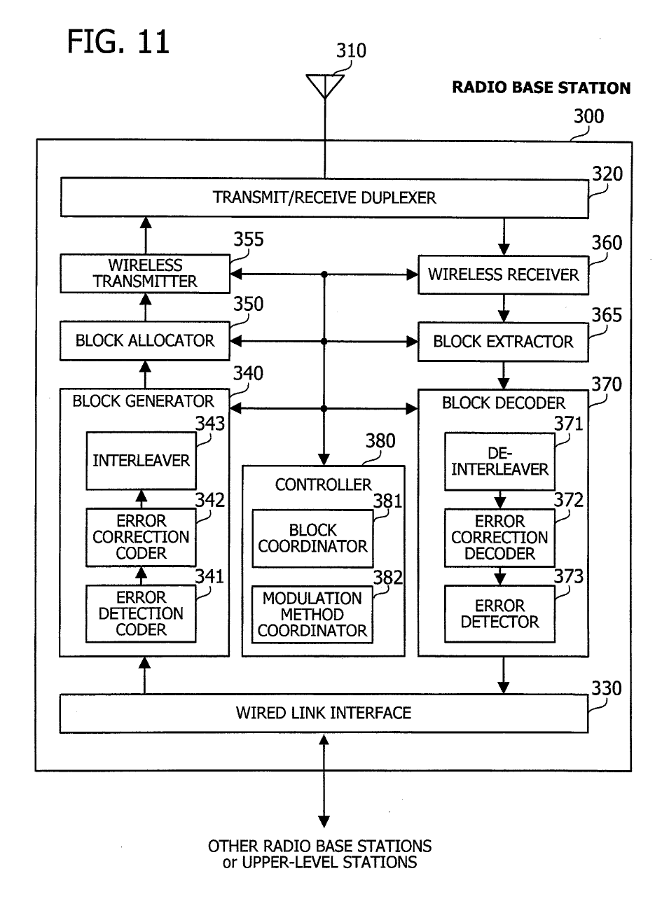

FIG. 11 is a block diagram illustrating a radio base station according to the second embodiment. This radio base station 300 is formed from an antenna 310, a transmit/receive duplexer 320, a wired link interface 330, a block generator 340, a block allocator 350, a wireless transmitter 355, a wireless receiver 360, a block extractor 365, a block decoder 370, and a controller 380. Note that the antenna 310, transmit/receive duplexer 320, wired link interface 330, block generator 340, block allocator 350, block extractor 365, and block decoder 370 are similar to those discussed in FIG. 3 in their functions and structures.

The wireless transmitter 355 modulates a carrier signal with radio frame data supplied from the block allocator 350, according to the modulation method specified by the controller 380. The wireless transmitter 355 then outputs the resulting transmit signal to the transmit/receive duplexer 320.

The wireless receiver 360 demodulates receive signals supplied from the transmit/receive duplexer 320, according to a demodulation method specified by the controller 380. The wireless receiver 360 then supplies the resulting radio frame data to the block extractor 365.

The controller 380 determines whether to allocate resources of UL subframe, in addition to those of DL subframe, for the purpose of transmission of DL blocks. This decision is made on the basis of, for example, the usage rates of DL and UL subframes or other parameters representing the current condition of communication. The controller 380 also selects a mobile station(s) for which such UL subframe resources will be used together with DL subframe resources to transmit DL blocks. This selection may be made arbitrarily or randomly or according to a particular sequence of mobile stations. It may also be possible to take into account the amount of transmit data and/or the quality of radio links, for example.

Similarly to the above, the controller 380 determines whether to allocate resources of DL subframe, in addition to those of UL subframe, for the purpose of reception of UL blocks. This decision is made on the basis of, for example, the usage rates of DL and UL subframes or other parameters representing the current condition of communication. The controller 380 also selects a mobile station(s) for which DL subframe resources will be used together with UL subframe resources so as to receive UL blocks. This selection may be made arbitrarily or randomly or according to a particular sequence of mobile stations. It may also be possible to take into account the amount of receive data and/or the quality of radio links, for example.

The controller 380 informs the block generator 340 and block decoder 370 of the block size and other parameters regarding DL and UL blocks. Another function of the controller 380 is to provide the block allocator 350 and block extractor 365 with information about locations of blocks in a radio frame. Yet another function of the controller 380 is to inform the wireless transmitter 355 and wireless receiver 360 of which modulation method will be used.

The controller 380 includes, among other things, a block coordinator 381 and a modulation method coordinator 382. The block coordinator 381 functions in the same way as the block coordinator 181 discussed earlier in FIG. 3. The modulation method coordinator 382 determines which modulation method to use in transmitting DL blocks and receiving UL blocks, based on block location information provided from the block coordinator 381. The choices may include phase shift keying (PSK) and quadrature amplitude modulation (QAM). Modulation methods with a lower transmission rate can provide a smaller block error rate under poor radio quality conditions.

Suppose, for example, that DL blocks are allocated a relatively high percentage of UL subframe resources. In this situation, the radio base station 300 is more likely to experience an increased block error rate. Accordingly, the modulation method coordinator 382 chooses a modulation method with a lower transmission rate in an attempt to maintain the current communication quality. To transfer the same amount of data with a low-rate modulation method, it is necessary to allocate a larger resource area to map the blocks. The block coordinator 381 therefore redefines the DL-MAP information.

The information about the newly selected modulation method is then delivered as part of radio frames to the receiving mobile station. Based on this information, the mobile station demodulates signals received from the radio base station 100, as well as modulating transmit signals to the radio base station 100, by using the new method.

The second embodiment uses the same radio frames as those illustrated in FIGS. 4 and 5; the explanation will not be repeated here. The following description gives details of several processes executed in the proposed radio communications system. It is assumed in this description that the radio base station 300 transmits and receives data to/from a plurality of mobile stations including a mobile station 200.

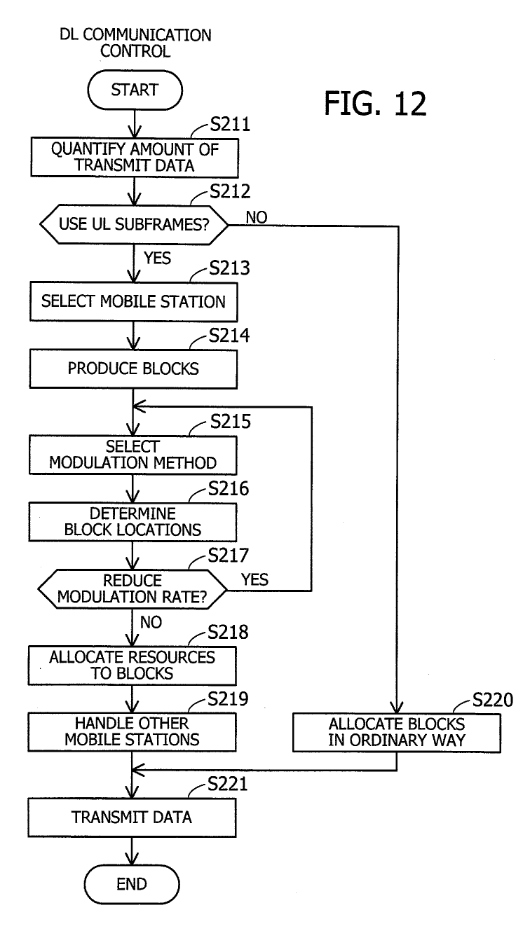

FIG. 12 is a flowchart of DL communication control according to the second embodiment. The illustrated process proceeds according to the following steps:

(Step S211) The controller 380 interacts with the wired link interface 330 to receive outgoing user data to be transmitted to mobile stations. The controller 380 then quantifies the amount of this user data and informs the block coordinator 381 of the result. Based on the information, the block coordinator 381 determines the size of a single DL block.

(Step S212) The controller 380 checks the current usage of DL and UL subframes to determine whether to use UL subframes to send DL blocks to mobile stations. For example, this determination may be made based on whether the usage rate of UL subframes is lower than a specific threshold. If it is determined to use UL subframes for DL block transmission, the process advances to step S213. If it is determined not to use UL subframes for DL block transmission, the process advances to step S220.

(Step S213) The controller 380 selects a mobile station(s) for which UL subframes are to be used in DL block transmission. This selection may be made arbitrarily or randomly or according to a particular sequence of mobile stations. It may also be possible to take into account the amount of transmit data and/or the quality of radio links, for example. The selection is not limited to a single mobile station; the controller 380 may select two or more mobile stations.

(Step S214) Based on the block size determined by the block coordinator 381, the block generator 340 divides the user data into blocks and subjects them to error detection coding, error correction coding, and interleaving operations. The block generator 340 then supplies the resulting DL blocks to the block allocator 350.

(Step S215) The modulation method coordinator 382 selects a modulation method for the DL blocks produced by the block generator 340.

(Step S216) The block coordinator 381 determines where in the radio frame to place the produced DL blocks, thus generating DL-MAP information. This DL-MAP information includes an identifier indicating the modulation method that the modulation method coordinator 382 has selected for each mobile station. In this processing, DL subframe resources are allocated to a part of each DL block for the mobile station selected at the above step S213, while the remaining part of each DL block is allocated UL subframe resources. The ratio between DL subframe resources and UL subframe resources allocated to each DL block may be determined by radio link quality requirements to achieve a specified QoS of DL blocks, or by the total usage rate of DL and UL subframes. The controller 380 then sends the produced DL-MAP information to the block allocator 350.

(Step S217) The modulation method coordinator 382 determines whether to change the modulation method to a lower-rate method in order to maintain a specified communication quality. This determination may be based on an estimate of block error rate of DL blocks to be transmitted. More specifically, the modulation method coordinator 382 may obtain a block error rate corresponding to the ratio of UL subframe resources used in DL blocks and then determine whether the obtained block error rate satisfies a specified quality requirement. When it is determined to change modulation methods, the process moves back to step S215 with choices for a new modulation method with a transmission rate lower than the present one. When it is determined not to change the present modulation method, the process advances to step S218.

(Step S218) According to the DL-MAP information provided from the controller 380, the block allocator 350 begins to produce radio frame data by executing the allocation of radio frame resources to the DL blocks supplied from the block generator 340. In this process, the block allocator 350 adds the DL-MAP information into the radio frame data.

(Step S219) The block allocator 350 now turns to other mobile stations, whose DL blocks will be transmitted in an ordinary way, i.e., by using only DL subframes. The block allocator 350 allocates DL subframe resources to DL blocks for those mobile stations, thus completing the production of radio frame data. The block allocator 350 then supplies the completed radio frame data to the wireless transmitter 355.

(Step S220) The block coordinator 381 determines where in the radio frame to place DL blocks of all mobile stations, so that the DL blocks will be transmitted in an ordinary way, i.e., by using only DL subframe resources. The results are compiled as DL-MAP information. The controller 380 then sends the produced DL-MAP information to the block allocator 350. Based on this DL-MAP information, the block allocator 350 allocates radio frame resources to the DL blocks, thus producing radio frame data for transmission via the wireless transmitter 355. In this process, the block allocator 350 adds the DL-MAP information into the radio frame data.

(Step S221) The wireless transmitter 355 modulates a carrier signal with the radio frame data supplied from the block allocator 350, according to the modulation method selected by the controller 380. The wireless transmitter 355 outputs the resulting transmit signal to the antenna 310 via the transmit/receive duplexer 320. The transmit signal is thus radiated as radio waves from the antenna 310 to mobile stations.

Through the above-described steps, the radio base station 300 changes modulation methods depending on radio link quality, besides allocating DL and UL subframe resources to transmit DL blocks to selected mobile stations. When a high block error rate is expected, the radio base station 300 chooses a modulation method with a low transmission rate to maintain the communication quality. The block coordinator 381 then redefines DL-MAP information since such a low-rate modulation method consumes a larger resource area to transfer the same amount of data.

In changing modulation methods, the block coordinator 381 may select successively lower rates. More particularly, but not exclusively, the transmission rate may be reduced by a predetermined decrement. The receiving mobile stations use the above DL-MAP information to extract DL blocks addressed to them, thereby obtaining user data contained therein.

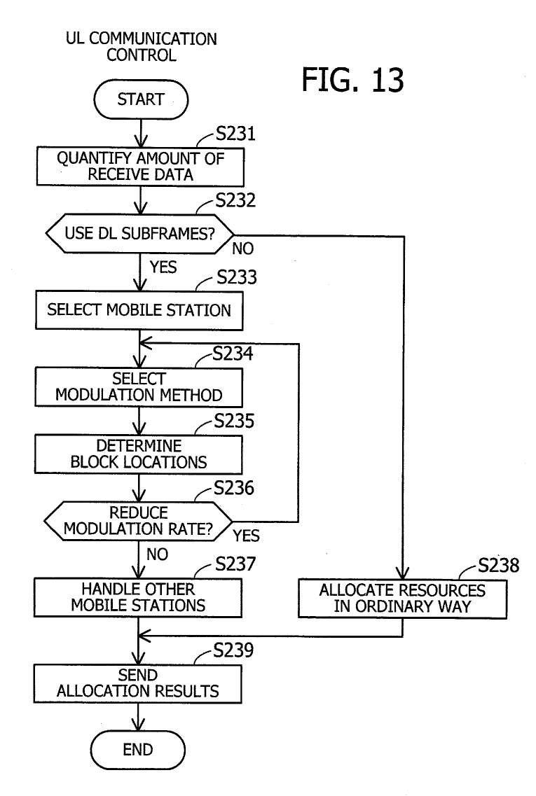

FIG. 13 is a flowchart of UL communication control according to the second embodiment. The illustrated process proceeds according to the following steps:

(Step S231) The controller 380 quantifies how much user data will be received from mobile stations and informs the block coordinator 381 of the result. Based on this information, the block coordinator 381 determines the size of a single UL block.

(Step S232) Based on the current usage of DL and UL subframes, the controller 380 determines whether to use DL subframes to receive blocks from mobile stations. This determination may be based on, for example, whether the usage rate of DL subframes is lower than a specific threshold. If it is determined to use DL subframe for block reception, the process advances to step S233. If it is determined not to use DL subframe for block reception, the process branches to step S238.

(Step S233) The controller 380 selects a mobile station(s) for which DL subframes are to be used in block reception. This selection may be made arbitrarily or randomly or according to a particular sequence of mobile stations. It may also be possible to take into account the amount of receive data and/or the quality of radio links, for example. The selection is not limited to a single mobile station. Rather, the controller 380 may select two or more mobile stations, depending on the usage rate of DL subframes.

(Step S234) The modulation method coordinator 382 selects a modulation method for UL blocks.

(Step S235) The block coordinator 381 determines where in the radio frame to place UL blocks, thus producing UL-MAP information. This UL-MAP information includes an identifier indicating the modulation method that the modulation method coordinator 382 has selected for each mobile station. In this processing, UL subframe resources are allocated to a part of each UL block for the mobile station selected at the above step S233, while the remaining part of each UL block is allocated DL subframe resources. The ratio between DL subframe resources and UL subframe resources allocated to each UL block may be determined by radio link quality requirements to achieve a specified QoS of that UL block, or by the total usage rate of DL and UL subframes.

(Step S236) The modulation method coordinator 382 determines whether to change the modulation method to a lower-rate method in order to maintain a specified communication quality. This determination may be based on an estimate of block error rate of UL blocks to be received. More specifically, the modulation method coordinator 382 may obtain a block error rate corresponding to the ratio of DL subframe resources used in UL blocks and then determine whether the obtained block error rate satisfies a specified quality requirement. When it is determined to change modulation methods, the process moves back to step S234 with choices for a new modulation method with a transmission rate lower than the present one. When it is determined not to change the present modulation method, the process advances to step S237.

(Step S237) The block coordinator 381 produces UL-MAP information for the other mobile stations, whose UL blocks will be transported by using only UL subframes.

(Step S238) The block coordinator 381 produces UL-MAP information for use by all mobile stations, so that UL blocks will be received in an ordinary way, i.e., by using only UL subframe resources.

(Step S239) The controller 380 then sends the produced UL-MAP information to the block allocator 350. In response, the block allocator 350 produces radio frame data containing this UL-MAP information. The produced radio frame data is transmitted as radio waves via the wireless transmitter 355, transmit/receive duplexer 320, and antenna 310.

Through the above-described steps, the radio base station 300 informs each mobile station of the modulation method selected according to radio link quality, besides providing UL-MAP information describing allocation of DL and UL subframe resources for use by the selected mobile stations. As in the case of DL communication control, the radio base station 300 chooses a new modulation method with a lower transmission rate to maintain the communication quality when a high block error rate is expected. The block coordinator 381 then redefines UL-MAP information since such a low-rate modulation method consumes a larger resource area to transfer the same amount of data.

In changing modulation methods, the block coordinator 381 may select successively lower-rate methods. More particularly, but not exclusively, the transmission rate may be reduced by a predetermined decrement. The mobile stations use assigned resources to transmit their UL blocks to the radio base station 300.

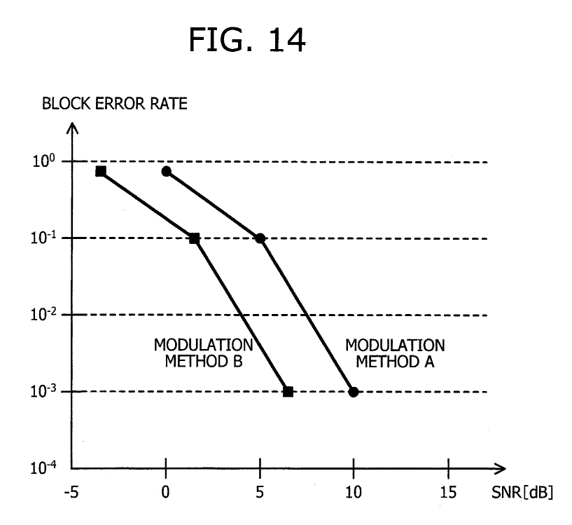

FIG. 14 is a second graph illustrating relationships between radio quality and block error rate. The horizontal axis of this graph represents SNR in units of dB, while the vertical axis represents block error rates. Plotted on the graph are two curves representing high-rate modulation method A and low-rate modulation method B.

Suppose, for example, that the radio base station 300 uses modulation method A to transmit DL blocks to the mobile station 200. Suppose also that DL subframes provide a radio link quality of 7.5 dB. FIG. 14 indicates that the corresponding block error rate in this case is 1.0×10⁻². When UL subframe resources are used to transmit DL blocks, possible interference from mobile stations in other cells may degrade the radio link quality to, for example, 0 dB at the mobile station 200. If this is the case, the block error rate will go up to 9.0×10⁻¹ as can be seen from FIG. 14.

Assuming that the radio base station 300 allocates DL subframe resources and UL subframe resources at the ratio of 1:2 for transmission of DL blocks, the resulting average radio link quality is about 4.0 dB per DL block. FIG. 14 indicates that the block error rate in this case is about 1.5×10⁻¹.

Suppose now that the radio base station 300 selects modulation method B to transmit DL blocks to the mobile station 200. Under the same conditions as the above-noted case of modulation method A, the block error rate will be 1.0×10⁻² as indicated in FIG. 14.

As can be seen from the above discussion, the second embodiment improves the block error rate more effectively, in addition to providing advantages similar to those of the first embodiment. While the above discussion is directed to block error rates of DL blocks sent from the radio base station 300 to the mobile station 200, the same discussion applies also to resource allocation of UL blocks that the radio base station 300 receives from the mobile station 200.

The above-described radio communications system permits coded blocks to be transmitted and received by using not only a portion of radio frame resources intended for respective link directions, but also a portion of radio frame resources that are not originally intended for respective link directions. In addition, the system may change modulation methods to those that transmit signals at a lower rate, depending on the radio link quality. This feature of the second embodiment improves the block error rate more effectively, besides providing advantages similar to those of the first embodiment.

### Third Embodiment

This section will describe a third embodiment of the present invention in detail with reference to the accompanying drawings. Because of the similarity of this third embodiment to the foregoing first embodiment, the following description will focus on their differences, not repeating the explanation of similar elements or features.

The foregoing first embodiment divides a radio frame along the time axis and uses both the resulting two subframes to allocate radio resources to coded blocks. Unlike the first embodiment, the third embodiment divides radio resources along the frequency axis, so that radio base station can use radio resources across two frequency bands.

The third embodiment is applied to a mobile communications system configured in the same way as the one illustrated in FIG. 2 for the first embodiment, the explanation of which will not be repeated here. This statement also applies to the internal structure of the proposed radio base station. That is, see FIG. 3 for details of the radio base station 100.

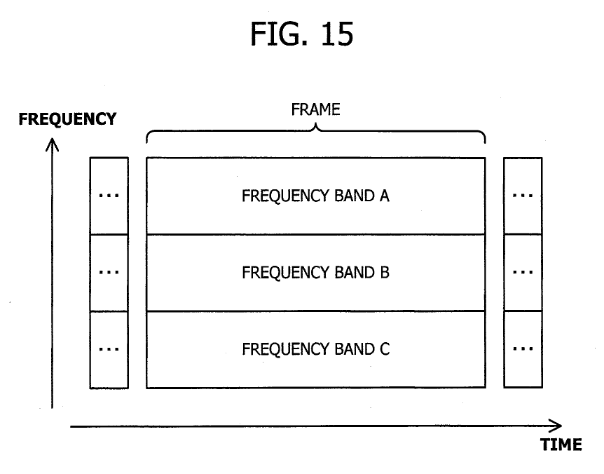

FIG. 15 illustrates a radio frame structure according to the third embodiment. This radio frame includes three frequency bands A, B, and C with specific ranges. Frequency band A is assigned to a radio base station 100. Frequency band B is assigned to another radio base station 100a. Frequency band C is assigned to yet another radio base station, which is adjacent to the radio base station 100. The bandwidths of those assigned frequency bands are determined previously, as is the time length of radio frames. The radio base station 100 and mobile station 200 transmit and receive radio signals repetitively by using corresponding resources contained in frequency band A. They may use FDD or TDD for bidirectional communication.

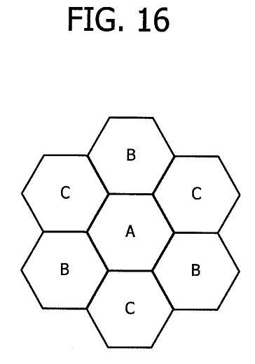

FIG. 16 illustrates allocation of frequency bands according to the third embodiment. Specifically, FIG. 16 gives an arrangement of radio coverage areas, or cells, provided by the radio base station 100 and other peer base stations. Frequency bands A, B, and C are assigned to those radio base stations in such a way that every pair of adjacent cells will not use the same frequency band, so as to minimize the radio signal interference between cells, particularly at the cell boundaries.

The following description gives details of several processes executed in the above-described radio communications system. It is assumed in this description that the radio base station 100 transmits and receives data to/from a plurality of mobile stations including a mobile station 200.

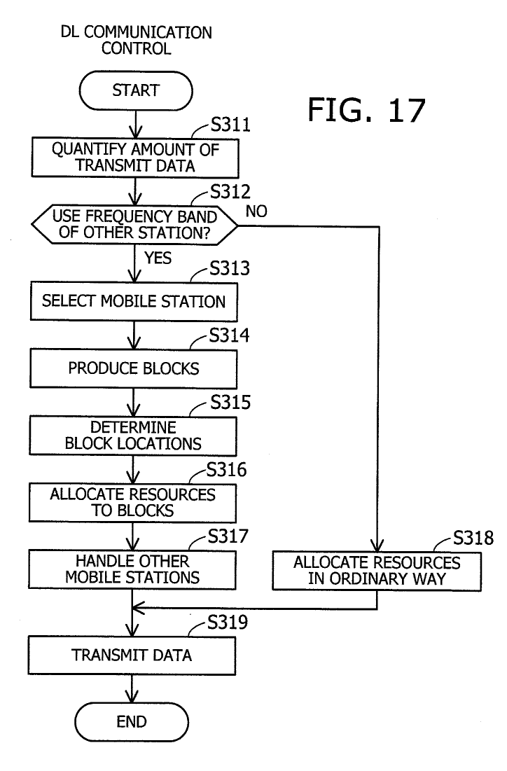

FIG. 17 is a flowchart of DL communication control according to the third embodiment. The illustrated process proceeds according to the following steps:

(Step S311) The controller 180 interacts with the wired link interface 130 to receive outgoing user data to be transmitted to mobile stations. The controller 180 then quantifies the amount of this user data and informs the block coordinator 181 of the result. Based on this information, the block coordinator 181 determines the size of a single DL block.

(Step S312) The controller 180 checks the current usage of frequency band A assigned to its local cell, as well as of frequency bands B and C assigned to radio base stations serving the neighboring cells. Based on the results, the controller 180 determines whether to use either of frequency bands B and C for transmission of DL blocks to mobile stations. This determination may be based on, for example, whether the usage rate of frequency band B or C is lower than a specific threshold. If it is determined to use some other station's frequency band for DL block transmission, the process advances to step S313. If it is determined not to use any other station's frequency band for DL block transmission, the process branches to step S318.

(Step S313) The controller 180 selects a mobile station(s) for which other station's frequency band is to be used to transmit DL blocks. This selection may be made arbitrarily or randomly or according to a particular sequence of mobile stations. It may also be possible to take into account the amount of transmit data and/or the quality of radio links, for example. The selection is not limited to a single mobile station; the controller 180 may select two or more mobile stations.

(Step S314) Based on the block size determined by the block coordinator 181, the block generator 140 divides the user data into blocks and subjects them to error detection coding, error correction coding, and interleaving operations. The block generator 140 then supplies the resulting DL blocks to the block allocator 150.

(Step S315) The block coordinator 181 determines where in the radio frame to place the produced DL blocks, thus generating DL-MAP information. In this processing, the block coordinator 181 allocates resources in its own frequency band A to a part of each DL block for the mobile station selected at the above step S313, while the remaining part of each DL block is allocated other station's band B (or C) resources. Here the block coordinator 181 determines the ratio between its own local frequency resources and other base stations' frequency resources to be allocated to each DL block. For example, this ratio may be determined by radio link quality requirements to achieve a specified QoS of DL blocks, or by the total usage rate of such frequency bands. The controller 180 then sends the produced DL-MAP information to the block allocator 150.

(Step S316) According to the DL-MAP information provided from the controller 180, the block allocator 150 begins to produce radio frame data by executing the allocation of radio frame resources to the DL blocks supplied from the block generator 140. In this process, the block allocator 150 adds the DL-MAP information into the radio frame data.

(Step S317) The block allocator 150 now turns to other mobile stations, whose DL blocks will be transmitted in an ordinary way, i.e., by using only frequency band A assigned to the radio base station 100. The block allocator 150 allocates resources of frequency band A to the DL blocks of those mobile stations, thus completing the production of radio frame data. The block allocator 150 then supplies the completed radio frame data to the wireless transmitter 155.

(Step S318) The block coordinator 181 produces DL-MAP information by placing DL blocks of every mobile station in an ordinary way, i.e., by using only frequency band A assigned to the radio base station 100. The controller 180 then sends the produced DL-MAP information to the block allocator 150. Based on this DL-MAP information, the block allocator 150 allocates radio frame resources to the DL blocks, thus producing radio frame data for transmission via the wireless transmitter 155. In this operation, the block allocator 150 adds the DL-MAP information into radio frame data to indicate how the resources are used in that radio frame.

(Step S319) The wireless transmitter 155 modulates a carrier signal with the radio frame data supplied from the block allocator 150, according to the modulation method specified by the controller 180. The wireless transmitter 155 outputs the resulting transmit signal to the antenna 110 via the transmit/receive duplexer 120. The transmit signal is thus radiated as radio waves from the antenna 110 to mobile stations.

Through the above-described steps, the radio base station 100 uses frequency band resources of other radio base stations, in addition to its own local frequency band resources, to transmit DL blocks to selected mobile stations. The receiving mobile stations use DL-MAP information to extract DL blocks addressed to them, thereby obtaining user data contained therein.

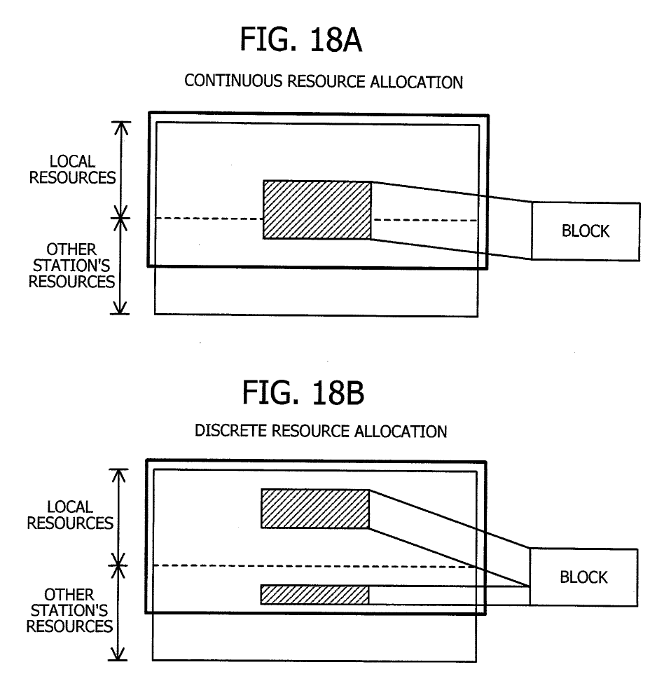

FIGS. 18A and 18B illustrate examples of DL block allocation according to the third embodiment. Specifically, FIG. 18A illustrates the case where the radio base station has placed a DL block in a continuous region of resources that lies across its own frequency band and that of another radio base station. This continuous resource allocation makes it easy for the receiving mobile stations to locate and read DL blocks, thus reducing their workload in decoding received data.

FIG. 18B, on the other hand, illustrates the case where the radio base station has placed a DL block in discrete regions of resources, one in its own frequency band and the other in some other radio base station's. This discrete resource allocation contributes to more flexible and efficient arrangement of blocks.

In the above examples of FIGS. 18A and 18B, the two frequency bands are immediately adjacent to each other. The third embodiment is, however, not limited to this arrangement. It may also be possible for the base station to select a frequency band that is away from its own frequency band, so that DL blocks can be placed in discrete regions.

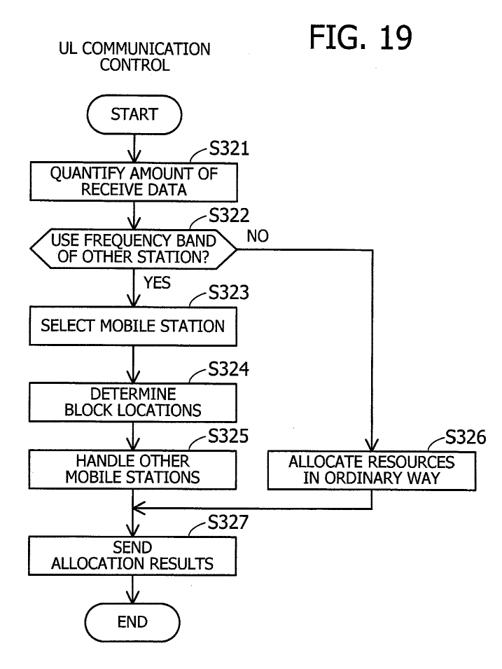

FIG. 19 is a flowchart of UL communication control according to the third embodiment. The illustrated process proceeds according to the following steps:

(Step S321) The controller 180 quantifies how much user data will be received from mobile stations and informs the block coordinator 181 of the result. Based on this information, the block coordinator 181 determines the size of a single UL block.

(Step S322) The controller 180 checks the current usage of frequency band A assigned to its local cell, as well as of frequency bands B and C assigned to radio base stations serving the neighboring cells. Based on the results, the controller 180 determines whether to use either of the frequency bands B and C for reception of blocks from mobile stations. This determination may be based on, for example, whether the usage rate of frequency band B or C is lower than a specific threshold. If it is determined to use some other station's frequency band to receive blocks, the process advances to step S323. If it is determined not to use any other station's frequency band to receive blocks, the process branches to step S326.

(Step S323) The controller 180 selects a mobile station(s) for which other station's frequency band is to be used to receive blocks. This selection may be made arbitrarily or randomly or according to a particular sequence of mobile stations. It may also be possible to take into account the amount of receive data and/or the quality of radio links, for example. The selection is not limited to a single mobile station; the controller 180 may select two or more mobile stations.

(Step S324) The block coordinator 181 determines where in the radio frame to place UL blocks, thus producing UL-MAP information. In this processing, the block coordinator 181 allocates resources in its own frequency band A to a part of each UL block for the mobile station selected at the above step S323, while the remaining part of each UL block is allocated resources of other station's frequency band B (or C). Here the block coordinator 181 determines the ratio between its own local frequency resources and other base stations' frequency resources to be allocated to each UL block. For example, this ratio may be determined by radio link quality requirements to achieve a specified QoS of UL blocks, or by the total usage rate of such frequency bands.

(Step S325) The block coordinator 181 produces UL-MAP information for other mobile stations, whose UL blocks will be transported by using only frequency band A.

(Step S326) The block coordinator 181 determines where in the radio frame to place UL blocks of all mobile stations, so that the UL blocks will be received in an ordinary way, i.e., by using only frequency band A. The results are compiled as UL-MAP information.

(Step S327) The controller 180 then sends the produced UL-MAP information to the block allocator 150. The block allocator 150 produces radio frame data containing this UL-MAP information. The produced radio frame data is transmitted as radio waves via the wireless transmitter 155, transmit/receive duplexer 120, and antenna 110.

Through the above-described steps, the radio base station 100 provides each mobile station with UL-MAP information describing allocation of its own and other stations' frequency band resources for use in reception of UL blocks from selected mobile stations. The mobile stations use assigned resources to transmit their own UL blocks to the radio base station 100.

The above-described radio communications system permits a radio base station to transmit and receive coded blocks by using not only a portion of frequency band resources intended for that station, but also a portion of frequency band resources that are not originally intended for that station, but assigned to other radio base stations. Even though the latter group of resources alone could not provide sufficient radio link quality, using them together with the former resources makes it possible to guarantee the average radio link quality of each coded block. In other words, the third embodiment achieves more efficient use of radio links since coded blocks can be mapped to other base stations' frequency band resources despite their originally intended use, while maintaining a required communication quality.

### Fourth Embodiment

This section will describe a fourth embodiment of the present invention in detail with reference to the accompanying drawings. Because of the similarity of this fourth embodiment to the foregoing second and third embodiments, the following description will focus on their differences, not repeating the explanation of similar elements or features.

The fourth embodiment introduces an adaptive modulation technique into the communication between a radio base station and mobile stations in a mobile communications system. This adaptive modulation system allows the radio base station to change modulation methods depending on the radio link quality of mobile stations. The fourth embodiment offers adaptive modulation that takes into consideration the size and arrangement of DL/UL blocks so that the mobile communications system can ensure a specified communication quality. The following description is directed to a radio base station and a mobile station used in such a mobile communications system.

The proposed mobile communication system of the fourth embodiment is configured in the same way as the first embodiment illustrated in FIG. 2. The radio base station includes the same functions as those of the radio base station 300 of FIG. 11 discussed in the second embodiment. Further, the radio frame structure of FIG. 15 discussed in the third embodiment also applies to the fourth embodiment.

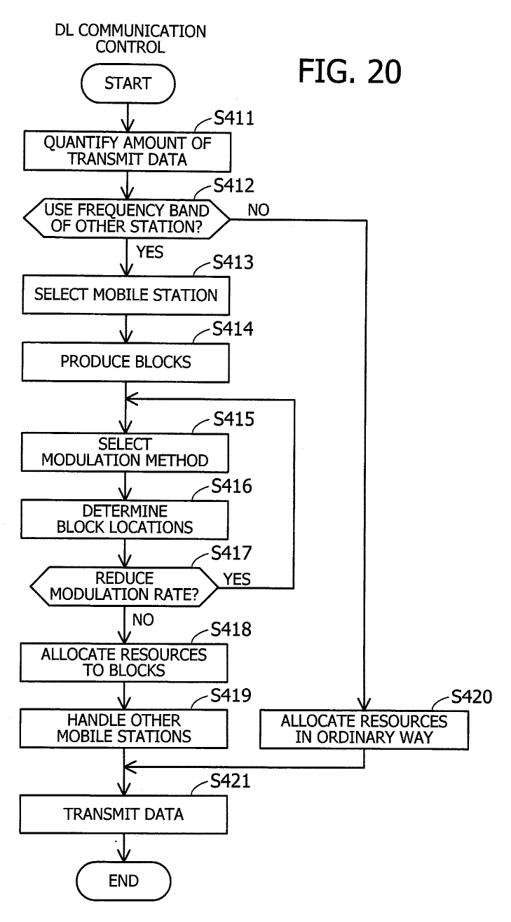

FIG. 20 is a flowchart of DL communication control of the fourth embodiment. The illustrated process proceeds according to the following steps:

(Step S411) The controller 380 interacts with the wired link interface 330 to receive outgoing user data to be transmitted to mobile stations. The controller 380 then quantifies the amount of this user data and informs the block coordinator 381 of the result. Based on this information, the block coordinator 381 determines the size of a single DL block.

(Step S412) The controller 380 checks the current usage of frequency band A assigned to its local cell, as well as of frequency bands B and C assigned to radio base stations serving the neighboring cells. Based on the results, the controller 380 determines whether to use either of frequency bands B and C for transmission of DL blocks to mobile stations. This determination may be based on, for example, whether the usage rate of frequency band B or C is lower than a specific threshold. If it is determined to use some other station's frequency band for DL block transmission, the process advances to step S413. If it is determined not to use any other station's frequency band for DL block transmission, the process branches to step S420.

(Step S413) The controller 380 selects a mobile station(s) for which other station's frequency band is to be used to transmit DL blocks. This selection may be made arbitrarily or randomly or according to a particular sequence of mobile stations. It may also be possible to take into account the amount of transmit data and/or the quality of radio links, for example. The selection is not limited to a single mobile station; the controller 380 may select two or more mobile stations.

(Step S414) Based on the block size determined by the block coordinator 381, the block generator 340 divides the user data into blocks and subjects them to error detection coding, error correction coding, and interleaving operations. The block generator 340 then supplies the resulting DL blocks to the block allocator 350.

(Step S415) The modulation method coordinator 382 selects a modulation method for the DL blocks produced by the block generator 340.

(Step S416) The block coordinator 381 determines where in the radio frame to place the produced DL blocks, thus generating DL-MAP information. This DL-MAP information includes an identifier indicating the modulation method that the modulation method coordinator 382 has selected for each mobile station. In this processing, the block coordinator 381 allocates resources of its own frequency band A to a part of each DL block for the mobile station selected at the above step S413. The remaining part of each DL block is allocated resources of other station's frequency band B (or C). Here the block coordinator 381 determines the ratio between its own local frequency resources and other base stations' frequency resources to be allocated to each DL block. For example, this ratio may be determined by radio link quality requirements to achieve a specified QoS of DL blocks, or by the total usage rate of such frequency bands. The controller 380 then sends the produced DL-MAP information to the block allocator 350.

(Step S417) The modulation method coordinator 382 determines whether to change the modulation method to a lower-rate method in order to maintain a specified communication quality. This determination may be based on an estimate of block error rate of DL blocks to be transmitted. More specifically, the modulation method coordinator 382 may obtain a block error rate corresponding to the ratio of its own and other radio base stations' frequency band resources used in DL blocks and then determine whether the obtained block error rate satisfies a specified quality requirement. When it is determined to change modulation methods, the process moves back to step S415 with choices for a new modulation method with a transmission rate lower than the present one. When it is determined not to change the present modulation method, the process advances to step S418.

(Step S418) According to the DL-MAP information provided from the controller 380, the block allocator 350 begins to produce radio frame data by executing the allocation of radio frame resources to the DL blocks supplied from the block generator 340. In this operation, the block allocator 350 adds the DL-MAP information into radio frame data to indicate how the resources are used in that radio frame.

(Step S419) The block allocator 350 now turns to other mobile stations, whose DL blocks will be transmitted in an ordinary way, i.e., by using only frequency band A assigned to its own station. The block allocator 350 allocates resources of frequency band A to the DL blocks of those mobile stations, thus completing the production of radio frame data. The block allocator 350 then supplies the completed radio frame data to the wireless transmitter 355.

(Step S420) The block coordinator 381 produces DL-MAP information by placing DL blocks of every mobile station in an ordinary way, i.e., by using only frequency band A assigned to its own station. The controller 380 then sends the produced DL-MAP information to the block allocator 350. Based on this DL-MAP information, the block allocator 350 allocates radio frame resources to the DL blocks, thus producing radio frame data for transmission via the wireless transmitter 355. In this operation, the block allocator 350 adds the DL-MAP information into radio frame data to indicate how the resources are used in that radio frame.

(Step S421) The wireless transmitter 355 modulates a carrier signal with the radio frame data supplied from the block allocator 350, according to the modulation method specified by the controller 380. The wireless transmitter 355 outputs the resulting transmit signal to the antenna 310 via the transmit/receive duplexer 320. The transmit signal is thus radiated as radio waves from the antenna 310 to mobile stations.

Through the above-described steps, the radio base station 300 changes modulation methods depending on radio link quality, besides allocating its own and other stations' frequency band resources to transmit DL blocks to selected mobile stations. When a high block error rate is expected, the radio base station 300 chooses a modulation method with a low transmission rate to maintain the communication quality. The block coordinator 381 then redefines DL-MAP information since such a low-rate modulation method consumes a larger resource area to transfer the same amount of data.

In changing modulation method, the block coordinator 381 may select successively lower rates. More particularly, but not exclusively, the transmission rate may be reduced by a predetermined decrement. The receiving mobile stations use the above DL-MAP information to extract DL blocks addressed to them, thereby obtaining user data contained therein.

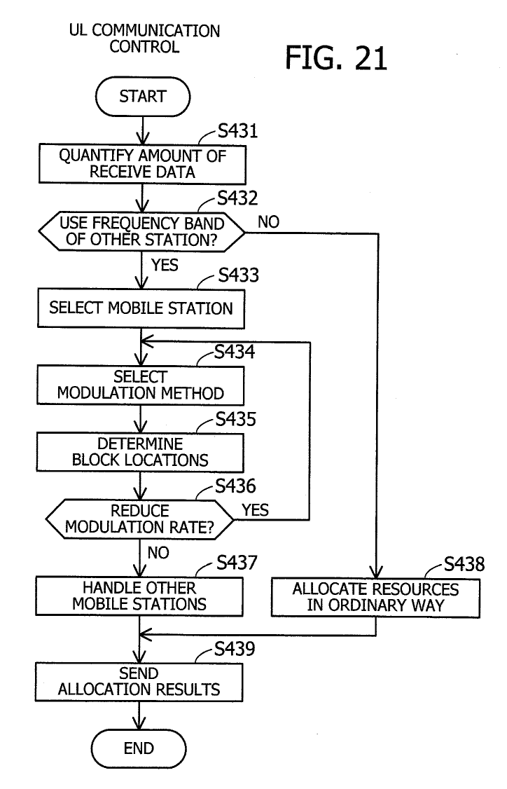

FIG. 21 is a flowchart of UL communication control according to the fourth embodiment. The illustrated process proceeds according to the following steps:

(Step S431) The controller 380 quantifies how much user data will be received from mobile stations and informs the block coordinator 381 of the result. Based on this information, the block coordinator 381 determines the size of a single UL block.

(Step S432) The controller 380 checks the current usage of frequency band A assigned to its local cell, as well as of frequency bands B and C assigned to radio base stations serving the neighboring cells. Based on the results, the controller 380 determines whether to use either of the frequency bands B and C for reception of blocks from mobile stations. This determination may be based on, for example, whether the usage rate of frequency band B or C is lower than a specific threshold. If it is determined to use some other station's frequency band to receive blocks, the process advances to step S433. If it is determined not to use any other station's frequency band to receive blocks, the process branches to step S438.

(Step S433) The controller 380 selects a mobile station(s) for which other station's frequency band is to be used to receive blocks. This selection may be made arbitrarily or randomly or according to a particular sequence of mobile stations. It may also be possible to take into account the amount of receive data and/or the quality of radio links, for example. The selection is not limited to a single mobile station; the controller 380 may select two or more mobile stations.

(Step S434) The modulation method coordinator 382 selects a modulation method for UL blocks.

(Step S435) The block coordinator 381 then determines where in the radio frame to place UL blocks, thus producing UL-MAP information. This UL-MAP information includes an identifier indicating the modulation method that the modulation method coordinator 382 has selected for each mobile station. In this processing, the block coordinator 381 allocates resources in its own frequency band A to a part of each UL block for the mobile station selected at the above step S433, while the remaining part of each UL block is allocated resources of other station's frequency band B (or C). Here the block coordinator 381 determines the ratio between its own local frequency resources and other base stations' frequency resources to be allocated to each UL block. For example, this ratio may be determined by radio link quality requirements to achieve a specified QoS of UL blocks, or by the total usage rate of such frequency bands.

(Step S436) The modulation method coordinator 382 determines whether to change the modulation method to a lower-rate method in order to maintain a specified communication quality. This determination may be based on an estimate of block error rate of UL blocks to be received. More specifically, the modulation method coordinator 382 may obtain a block error rate corresponding to the ratio of other station's frequency band resources used to receive UL blocks and then determine whether the obtained block error rate satisfies a specified quality requirement. When it is determined to change modulation methods, the process moves back to step S434 with choices for a new modulation method with a transmission rate lower than the present one. When it is determined not to change the present modulation method, the process advances to step S437.

(Step S437) The block coordinator 381 produces UL-MAP information for other mobile stations, whose UL blocks will be transported by using only frequency band A.

(Step S438) The block coordinator 381 determines where in the radio frame to place UL blocks of all mobile stations, so that their UL blocks will be received in an ordinary way, i.e., by using only frequency band A. The results are compiled as UL-MAP information.

(Step S439) The controller 380 then sends the produced UL-MAP information to the block allocator 350. In response, the block allocator 350 produces radio frame data containing this UL-MAP information. The produced radio frame data is transmitted as radio waves via the wireless transmitter 355, transmit/receive duplexer 320, and antenna 310.

Through the above-described steps, the radio base station 300 provides each mobile station with UL-MAP information. This UL-MAP information not only describes the allocation of frequency band resources of the radio base station 300 and other base stations used to receive UL blocks from selected mobile stations, but also indicates a modulation method selected according to the current radio link quality. As in the case of DL communication control, the radio base station 300 chooses a new modulation method with a lower transmission rate to maintain the communication quality when a high block error rate is expected. The block coordinator 381 then redefines UL-MAP information since such a lower-rate modulation method consumes a larger resource area to transfer the same amount of data.

In changing modulation methods, the block coordinator 381 may select successively lower-rate methods. More particularly, but not exclusively, the transmission rate may be reduced by a predetermined decrement. The mobile stations use assigned resources to transmit their own UL blocks to the radio base station 300.

The above-described radio communications system permits a radio base station to transmit and receive coded blocks by using not only a portion of frequency band resources intended for that base station, but also a portion of frequency band resources that are not originally intended for that station, but assigned to other radio base stations. In addition, the system may change modulation methods to those that transmit signals at a lower rate, depending on the radio link quality. This feature of the fourth embodiment improves the block error rate more effectively, besides providing advantages similar to those of the third embodiment.

The above description has illustrated several mobile communication systems involving radio base stations and mobile stations. The present invention is, however, not limited to those systems, but can be applied to other types of communication systems. For example, the mobile communication methods discussed in the first to fourth embodiments can also be applied to fixed wireless communication systems.

In the foregoing second and fourth embodiments, the uplink and downlink channels select their modulation methods independently. These embodiments may be modified such that the uplink and downlink channels may share the same modulation method. Further, the actual implementation may combine the radio communication methods discussed in the first and second embodiments with those of the third and fourth embodiments.

As can be seen from the above description, the proposed features contribute to increased efficiency of radio resource usage, without imposing limitations on applicable mobile stations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions and alterations could be made hereto without departing from the spirit and scope of the invention.

What is claimed is:

1. A radio base station that transmits data in the form of error correction coded blocks, the radio base station comprising:
a controller which allocates radio resources belonging to a first set of radio resources to one part of a block of data, as well as radio resources belonging to a second set of radio resources to the other part of the block, the first set of radio resources being a set of radio resources assigned to the radio base station for use in data transmission, the second set of radio resources being a set of radio resources other than the first set of radio resources; and
a transmitter which transmits the block by using the radio resources allocated by the controller.

2. The radio base station according to claim 1, wherein, of all radio resources assigned to the radio base station,
the first set of radio resources is defined as a set of resources for use in downlink communication, and
the second set of radio resources is defined as a set of resources for use in uplink communication.

3. The radio base station according to claim 1, wherein, of all radio resources used by said radio base station and other radio base stations,
the first set of radio resources is defined as a set of resources for use by said radio base station, and
the second set of radio resources is defined as a set of resources for use by said other radio base stations.

4. The radio base station according to claim 1, wherein:
the controller determines which modulation method to use, based on a ratio between said one part of the block and said other part of the block in terms of data size; and
the transmitter modulates a carrier signal with the block of data by using the modulation method that the controller has determined.

5. A radio base station that receives data from a mobile station in the form of error correction coded blocks, the radio base station comprising:
a controller which allocates radio resources belonging to a first set of radio resources to one part of a block of data, as well as radio resources belonging to a second set of radio resources to the other part of the block, the first set of radio resources being a set of radio resources assigned to said radio base station for use in data reception, the second set of radio resources being a set of radio resources other than the first set of radio resources; and
a transmitter which transmits to the mobile station a piece of information indicating the radio resources that the controller has allocated.

6. The radio base station according to claim 5, wherein, of all radio resources assigned to the radio base station,
the first set of radio resources is defined as a set of resources for use in uplink communication, and
the second set of radio resources is defined as a set of resources for use in downlink communication.

7. The radio base station according to claim 5, wherein, of all radio resources used by said radio base station and other radio base stations,
the first set of radio resources is defined as a set of resources for use by said radio base station, and
the second set of radio resources is defined as a set of resources for use by said other radio base stations.

8. The radio base station according to claim 5, wherein
the controller determines which modulation method to use, based on a ratio between said one part of the block and said other part of the block in terms of data size; and
the transmitter modulates a carrier signal with the block of data by using the modulation method that the controller has determined.

9. A method executed by a radio base station to transmit data in the form of error correction coded blocks, the method comprising:
allocating radio resources belonging to a first set of radio resources to one part of a block of data, as well as radio resources belonging to a second set of radio resources to the other part of the block, the first set of radio resources being a set of radio resources assigned to the radio base station for use in data transmission, the second set of radio resources being a set of radio resources other than the first set of radio resources; and
transmitting the block by using the allocated radio resources.

10. A method executed by a radio base station to receive data from a mobile station in the form of error correction coded blocks, the method comprising:
allocating radio resources belonging to a first set of radio resources to one part of a block of data, as well as radio resources belonging to a second set of radio resources to the other part of the block, the first set of radio resources being a set of radio resources assigned to the radio base station for use in data reception, the second set of radio resources being a set of radio resources other than the first set of radio resources; and
transmitting to the mobile station a piece of information indicating the allocated radio resources.
